(19) United States
(12) Patent Application Publication
(10) Pub. No.: US 2009/0258268 A1
(43) Pub. Date: Oct. 15, 2009

(54) FUEL CELL SYSTEM WITH FUEL CELL STACK RECEPTACLE

(76) Inventor: Kemal Ozgur, West Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/410,239

(22) Filed: Mar. 24, 2009

Related U.S. Application Data
(60) Provisional application No. 61/039,359, filed on Mar. 25, 2008.

(51) Int. Cl. H01M 8/04; H01M 2/02

(52) U.S. Cl. 429/22; 429/34; 429/26

(57) ABSTRACT

A fuel cell system with a fuel cell stack receptacle that encloses at least one fuel cell stack and at least one fuel cell stack peripheral, and retains the fuel cell stack(s) in a compressed state.

### CROSS REFERENCE TO RELATED APPLICATIONS

This application claims benefit under 35 U.S.C. 11 9(e) of U.S. Provisional Patent Application Ser. No. 61/039,359, filed Mar. 25, 2008, entitled “Fuel Cell System with Fuel Cell Stack Receptacle”, which is incorporated herein by reference in its entirety.

### BACKGROUND

1. Field

The present disclosure relates generally to fuel cell systems that include one or more fuel cell stacks and one or more fuel cell stack peripherals.

2. Description of the Related Art

Fuel cells convert fuel and oxidant to electricity and reaction product. Solid polymer electrochemical fuel cells employ a membrane electrode assembly (“MEA”) disposed between two electrically conductive flow field plates. The MEA is comprised of a polymer electrolyte membrane (“PEM”) (or ion exchange membrane) disposed between two electrodes. The electrodes comprise porous, electrically conductive sheet material. An electrocatalyst is disposed at each membrane/electrode layer interface to induce the desired electrochemical reaction. Fluid flow field plates have at least one flow passage formed therein to direct the fuel and oxidant to the respective electrodes, namely, the anode on the fuel side and the cathode on the oxidant side. The plates also act as current collectors and provide mechanical support for the electrodes. Commercial PEMs include sulfonated perfluorocarbon membrane sold by E.I. Du Pont de Nemours and Company under the trade designation NAFION®. Electrocatalysts typically comprise a precious metal composition (e.g., platinum metal black or an alloy thereof) and may be provided on a suitable support (e.g., fine platinum particles supported on a carbon black support).

At the anode, fuel, typically in the form of hydrogen gas, reacts at the electrocatalyst in the presence of the PEM to form hydrogen ions and electrons. At the cathode, oxidant reacts at the electrocatalyst in the presence of the PEM to form oxygen anions. The PEM facilitates the migration of the hydrogen ions from the anode to the cathode where they react with ions formed at the cathode. The electrons pass through an external circuit, creating a flow of electricity. The net reaction product is water. The anode and cathode reactions are shown below:

H₂→2H⁺+2e⁻ (1)

½O₂+2H⁺+2e⁻→H₂O (2)

Multiple fuel cells may be connected together in series to form a fuel cell stack. In such an arrangement, one side of a given flow field plate may serve as an anode flow field plate for one cell and the other side of the flow field plate may serve as the cathode flow field plate for the adjacent cell. The fuel cell stack is then compressed to ensure sufficient electrical contact, electrochemical contact and sealing of the various components of the fuel cell stack described above. Fuel cell stacks known in the art are held in a compressed state by tie rods or compression bands. For example, U.S. Pat. No. 5,484,666 discloses a fuel cell stack where a tie rod extends within an opening and through each of the first and second end plates with fastening means disposed at opposite ends of the tie rod and with compressive means interposed between at least one of the fastening means and at least one of the first and second end plates. In operation, the fastening means and the compressive means urge the first end plate toward the second end plate, thereby applying compressive force to the fuel cells in the fuel cell stack. U.S. Pat. No. 5,789,091 discloses a mechanism for securing the stack in its compressed, assembled state including at least one compression band which circumscribes the end plate assemblies of the fuel cell stack urging the first end plate assembly toward the second end plate assembly thereby applying a compressed force to the fuel cells in the stack.

The compressed fuel cell stack may then be placed in an enclosure which may include other components such as an external manifold, bus bars, electronic and monitoring devices. Electrical and fluid connections between the stack and the peripherals may be made via the enclosure. For example, U.S. Pat. No. 6,862,801 discloses a receptacle having an end cap, a pliable sidewall, and a fastener that retains the fuel cell stack in its stacked configuration under at least partial compression during fabrication of a multi-stack fuel cell assembly. However, manifold and/or balance of plant elements are located outside the receptacle.

Accordingly, there remains a need for improved and simplified apparatus for compressing and enclosing a fuel cell stack and peripheral balance of plant elements. The present disclosure addresses these needs and provides further related advantages.

### BRIEF SUMMARY

At least one embodiment may be summarized as a fuel cell system, including a first fuel cell stack; a fuel cell stack peripheral operationally coupled to the first fuel cell stack; and a fuel cell stack receptacle sized and shaped, when assembled, to receive and at least partially enclose the first fuel cell stack in an interior of the fuel cell stack receptacle and to receive and at least partially enclose the fuel cell stack peripheral in the interior of the fuel cell stack receptacle, the fuel cell stack receptacle comprising: a base, a plurality of sidewalls and at least one fastener; wherein the fastener, the base and at least one of the plurality of sidewalls are adapted to cooperatively retain the first fuel cell stack in a compressed state.

The fuel cell peripheral may retain the first fuel cell stack in a compressed state in cooperation with the fastener, the base, and the at least one of the plurality of sidewalls. The first fuel cell stack may be retained in the compressed state by a compression force of a first predetermined magnitude.

The fuel cell system of claim 1 may further include an electrically insulating material interposed between the first fuel cell stack and at least one of the base, the at least one of the plurality of sidewalls and the fastener to electrically isolate the first fuel cell stack from at least one of the base, the at least one of the plurality of sidewalls and the fastener. The first fuel cell stack may be retained in an insulation enclosure in a compressed state of a second predetermined magnitude that is less than the first predetermined magnitude. The fuel cell stack peripheral may include a manifold. The fuel cell stack peripheral may be an end cell heater. The fuel cell stack peripheral may be an electronic controller that controls one of the operating parameters of the fuel cell stack. The fuel cell stack receptacle may include an access panel. The fuel cell stack receptacle may have at least one port that provides access to the interior of the fuel cell stack receptacle for the flow of reactant. The fuel cell stack receptacle may include at least one electrical junction that provides access to the interior of the fuel cell stack receptacle for the flow of electricity. The fuel cell stack receptacle may further include a lid. The lid may be sealed to at least one of the plurality of sidewalls to enclose the first fuel cell stack and fuel cell stack peripheral in the interior of the fuel cell stack receptacle.

The fuel cell system may further include a second fuel cell stack; and an electrically insulating material, wherein the fuel cell stack receptacle is further sized and shaped to receive the second fuel cell stack in the interior of the fuel cell stack receptacle and wherein the insulating material is interposed between the first fuel cell stack and the second fuel cell stack.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a plan view of a fuel cell stack receptacle according to one illustrated embodiment, shown in an unassembled state.

FIG. 2 is an isometric view of a fuel cell system according to one illustrated embodiment, employing the fuel cell stack receptacle of the embodiment of FIG. 1, shown in an assembled state, and including a fuel cell stack and a fuel cell stack peripheral received in an interior of the fuel cell stack receptacle.

FIG. 3 is a plan view of a fuel cell stack receptacle according to another illustrated embodiment, shown in an unassembled state.

FIG. 4 is an isometric view of fuel cell system according to another illustrated embodiment, employing the fuel cell stack receptacle of the embodiment of FIG. 3, shown in an assembled state, and including two fuel cell stacks and at least one fuel cell stack peripheral received in an interior of the fuel cell stack receptacle.

FIG. 4B is a plan view of a fuel cell system according to another illustrated embodiment including two fuel cell stacks and an insulating material disposed between the fuel cell stacks.

FIG. 4C is a plan view of a fuel cell system according to another illustrated embodiment including two fuel cell stacks each at least partially enclosed within an insulating receptacle each at least partially enclosed within the fuel cell stack receptacle.

FIG. 5 is an isometric view of a fuel cell system according to another illustrated embodiment including a fuel cell stack receptacle, shown in an assembled state, at least one fuel cell stack and at least one fuel cell stack peripheral.

FIG. 6 is a plan view of a fuel cell stack receptacle according to one illustrated embodiment, shown in an unassembled state.

FIG. 7 is an isometric view of a fuel cell system according to another illustrated embodiment, employing the fuel cell stack receptacle of the embodiment of FIG. 6, shown in an assembled state, and including a fuel cell stack and a fuel cell stack peripheral received in an interior of the fuel cell stack receptacle.

### DETAILED DESCRIPTION

In the following description, certain specific details are set forth in order to provide a thorough understanding of various embodiments of the disclosure. However, one skilled in the art will understand that the subject of the disclosure may be practiced without these details. In other instances, well-known structures associated with fuel cells, fuel cell stacks, and fuel cell systems have not been shown or described in detail to avoid unnecessarily obscuring descriptions of the embodiments of the disclosure.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

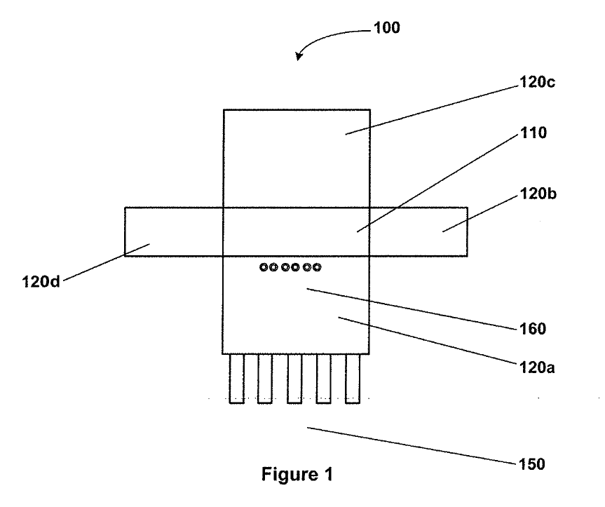

FIG. 1 is a plan view of a fuel cell stack receptacle 100 according to one illustrated embodiment, shown in an unassembled state. Fuel cell stack receptacle 100 can be assembled to receive and at least partially enclose a fuel cell stack along with at least one fuel cell stack peripheral element, to maintain the fuel cell stack in a compressed state. Fuel cell stack receptacle 100 in this embodiment comprises a base 110 and sidewalls 120a-120d which are attached to base 110 and/or to each other (in an assembled state) that form an interior or cavity sized and shaped to closely receive the fuel cell stack (not shown in FIG. 1) and to also receive at least one fuel cell stack peripheral (not shown in FIG. 1). Fasteners 150 extend from, are fixed to or otherwise coupled to at least one sidewall 120a, to mechanically attach sidewall 120a to sidewall 120c. Fasteners 150, in cooperation with sidewalls 120a-120d and base 110, in an assembled state, maintain the fuel cell stack in a compressed state so as to permit proper operation of the fuel cell stack. In this embodiment, fuel cell stack receptacle 100 also includes one or more ports 160 for the ingress and egress of reactants and/or coolant and also includes electrical connections 164 for the flow of electricity from the fuel cell stack to a load (not shown).

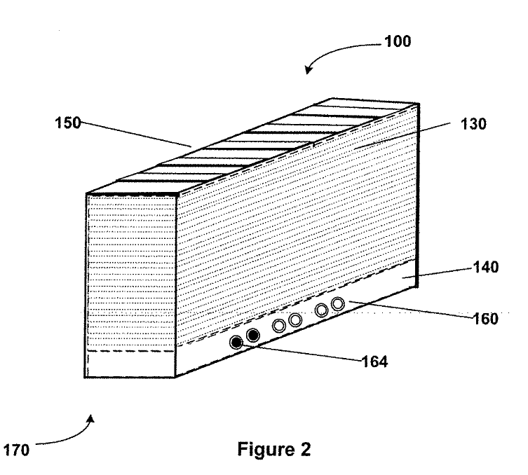

FIG. 2 is an isometric view of fuel cell system 170 according to one illustrated embodiment. The fuel cell system 170 employs the fuel cell stack receptacle 100 of the embodiment of FIG. 1, shown in an assembled state. The fuel cell system 170 further includes a fuel cell stack 130 (shown in broken line) and a fuel cell peripheral 140 (also shown in broken line) enclosed within an interior or cavity of the fuel cell stack receptacle 100. As can be seen in FIG. 2, ports 160 interface with fuel cell stack peripheral 140 which in the embodiment of this Figure may be a manifold configured and coupled to receive and direct reactants (air and hydrogen) and coolant to and from the fuel cell stack.

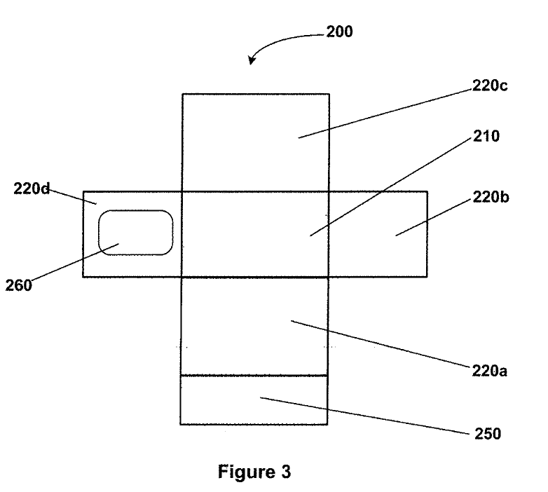

FIG. 3 is a plan view of fuel cell stack receptacle 200 according to another illustrated embodiment, shown in an unassembled state. The fuel cell stack receptacle 200 can be assembled to receive and to at least partially enclose a fuel cell stack (not shown in FIG. 3) and at least one fuel cell stack peripheral element (not shown in FIG. 3) and to maintain the fuel cell stack in a compressed state. Fuel cell stack receptacle 200 in this embodiment comprises a base 210 and sidewalls 220a-220d which are attached or coupled to base 210 and to each other (in an assembled state) that form an interior or cavity sized and shaped to closely receive multiple fuel cell stacks (not shown in FIG. 3) and at least one fuel cell stack peripheral. Fastener 250 extends from, is fixed to, or otherwise coupled to sidewall 220a to mechanically attach sidewall 220a to sidewall 220c. In an assembled state, fastener 250 cooperates with sidewalls 220a, 220c and base 210 to maintain the fuel cell stacks (not shown in FIG. 3) in a compressed state so as to permit proper operation of the fuel cell stack. Fuel cell stack receptacle 200 includes access panel 260 to provide access to the interior of fuel cell receptacle for various reasons including the installation of electrical components, to allow for ingress and egress of reactant and coolant and/or for the electrical connection to a load (not shown) or for testing, diagnostic or maintenance purposes.

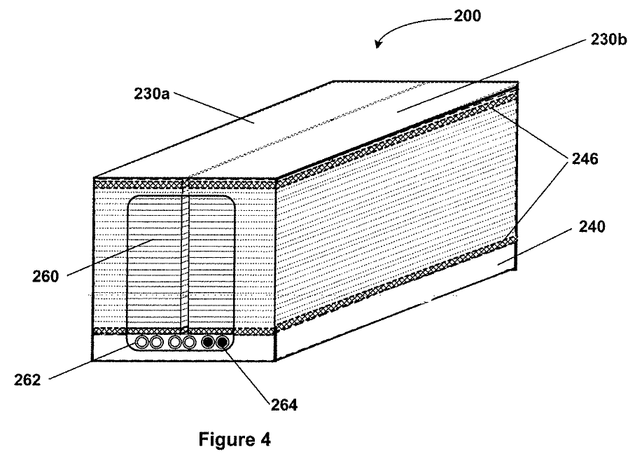

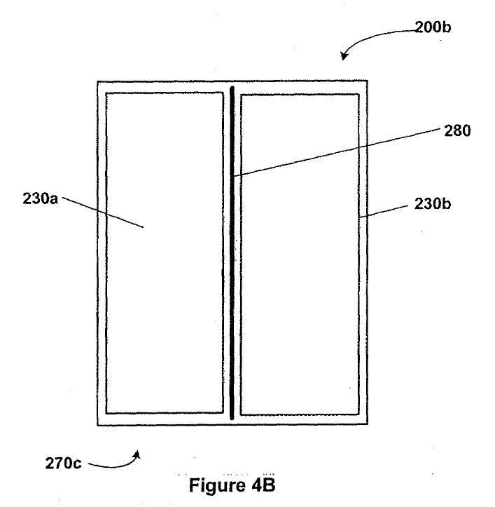

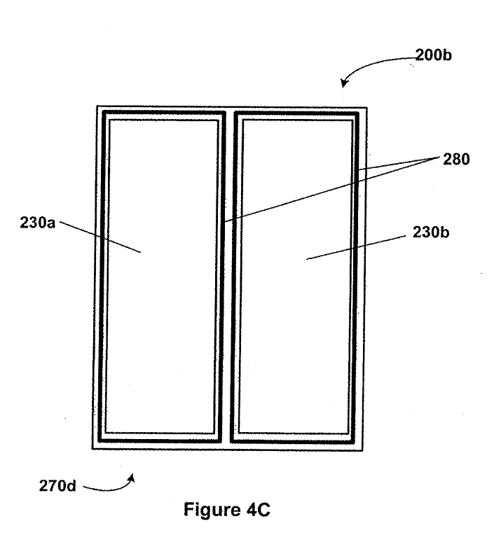

FIG. 4 is an isometric view of a fuel cell system 270 according to one illustrated embodiment. The fuel cell system 270 employs the fuel cell receptacle 200 of the embodiment of FIG. 3, shown in an assembled state. The fuel cell system 270 further includes at least two fuel cell stacks 230a, 230b (partially shown in broken lines) and at least one fuel cell stack peripheral 240 (also partially shown in broken line). As can be seen in FIG. 4, access panel 260 provides access to the inside of fuel cell receptacle to allow for the installation of electrical components, or connections for the ingress and egress of reactant and coolant via ports 262 and for the electrical connection to a load via junctions 264 or for testing, diagnostic or maintenance purposes.

FIG. 4B is a plan view showing a fuel cell system 270b according to one illustrated embodiment. Fuel cell stack system 270c includes an electrically insulating material 280 interposed between fuel cell stack 230a and fuel cell stack 230b to electrically isolate fuel cell stack 230a from fuel cell stack 230b.

FIG. 4C is a plan view showing a fuel cell system 270c according to one illustrated embodiment. Fuel cell stack receptacle 200c includes electrically insulating enclosures 280c for at least partially enclosing fuel cell stacks 230a and 230b, respectively, to electrically isolate fuel cell stack 230a from fuel cell stack 230b and from the fuel cell stack enclosure 200c and other elements (not shown). Insulating enclosures 280c may further be adapted to retain the associated fuel cell stack in a partially compressed state. Suitable insulating materials include LEXAN® or other such materials. A person of ordinary skill in the art may select an appropriate insulating material for a particular application.

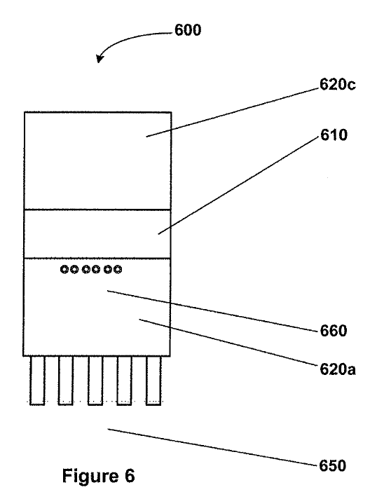

Not all sides of an enclosed fuel cell stack need to have an associated sidewall. FIG. 6 is a plan view of fuel cell stack receptacle 600 according to one illustrated embodiment, shown in an unassembled state. Fuel cell stack receptacle 600 can be assembled to receive and at least partially enclose at least one fuel cell stack (not shown in FIG. 6) and at least one fuel cell stack peripheral element, and to maintain the fuel cell stack(s) in a compressed state. Fuel cell stack receptacle 600 in this embodiment comprises a base 610 and sidewalls 620a and 620b which are attached to base 610 and spaced from one another to receive at least one fuel cell stack (not shown) and at least one fuel cell stack peripheral therebetween. Fastener 650 extends from sidewall 620a to mechanically attach sidewall 620a to sidewall 620b. In an assembled state, fastener 650 physically cooperates with sidewalls 620a and sidewall 620c and base 210 to maintain the fuel cell stack (not shown) in a compressed state so as to permit proper operation of the fuel cell stack.

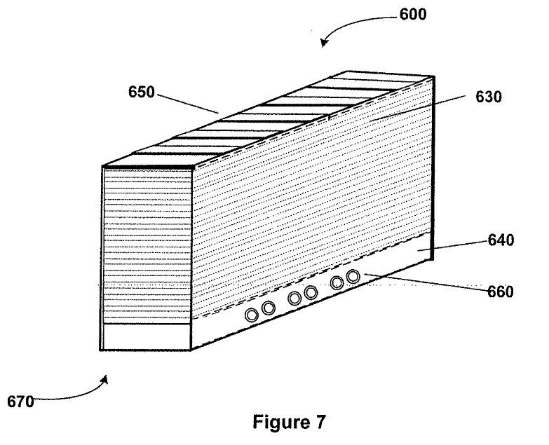

FIG. 7 is an isometric view of a fuel cell system 670, according to one illustrated embodiment. The fuel cell system 670 employs the fuel cell stack receptacle 600 of the embodiment of FIG. 6, shown in an assembled state. The fuel cell system 670 further includes a fuel cell stack 630 (shown in broken line where obscured by a sidewall) and a fuel cell peripheral 640 (also shown in broken line where obscured by a sidewall) enclosed within an interior of the fuel cell stack receptacle 600. As can be seen in FIG. 7, one or more ports 660 interface with fuel cell stack peripheral 640 which in the embodiment illustrated in this Figure may be a manifold configured and coupled to receive and direct reactants (air and hydrogen) and coolant to and from the fuel cell stack.

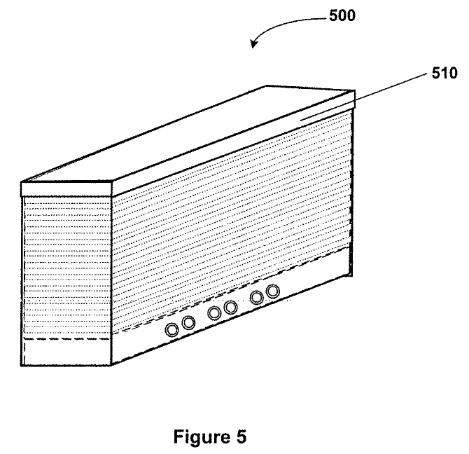

Fasteners disclosed above may be in the form of straps or tabs extending from a sidewall to mechanically attach to another sidewall, as disclosed in FIG. 1 or may be in the form of a substantially complete sidewall as disclosed in FIG. 2. Other forms of fasteners may be selected by a person of ordinary skill in the art for a particular application. Fasteners may be mechanically attached by welding, bolting, riveting, industrial adhesives or other means known in the art provided the attachment is sufficiently strong to withstand the tension required to maintain the fuel cell stack in a compressed state. A person of ordinary skill in the art may select the fasteners to join sidewalls by a butt-end joint, overlapping joint or by any other joint known in the art. A person of ordinary skill in the art may also select fasteners to extend from one sidewall or from opposing sidewalls, for example. Where fasteners are in the form of straps, as disclosed in FIG. 1 above, on in a form that does not completely enclose the fuel cell stack and fuel cell stack peripheral, the fuel cell stack receptacle may further comprise a lid for further enclosing the fuel cell stack(s) and fuel cell stack peripheral(s) as is shown in FIG. 5 Lid 510 may be further sealed to sidewalls of fuel cell stack enclosure 500 by caulking, welding, or other sealing means known by a person of ordinary skill in the art.

A fuel cell stack receptacle may fully enclose and seal the received fuel cell stack(s) and fuel cell stack peripheral(s), as disclosed above, against the external environment to prevent the ingress of contaminant material to the fuel cell stack and fuel cell stack system. For example, in an automotive application, water, road dirt and grime, road salt, and salt water, for example, may be excluded from the fuel cell stack(s) and fuel cell stack peripheral(s) ensuring normal operation. In addition, fuel cell stack(s) and fuel cell stack peripheral(s) may leak reactant, such as hydrogen gas. Where the fuel cell stack receptacle fully encloses and seals the received fuel cell stack(s) and fuel cell stack peripheral(s) against the external environment, the leaked reactant may be accumulated within the fuel cell stack receptacle and purged in a controlled manner.

The fuel cell stack receptacle may be constructed or formed by any method known in the art and may include planar or curved portions so as to accommodate the shape of the received fuel cell stack. For example, a person of ordinary skill in the art may select to manufacture fuel cell receptacle out of aluminum, stainless steel sheet metal, Lexan® or other materials known in the art. For example, the fuel cell stack receptacle may further include curved portions, such as curved transitions between the base and sidewalls, so as to provide an even compression load from the fuel cell stack receptacle to the fuel cell stack(s).

The fuel cell stack receptacle base and sidewalls may be of the same or differing materials from one another, may be cut from a single material or may be assembled into fuel cell stack receptacle by folding or by means of mechanical fastening such as welding, bolting, riveting etc.

As disclosed above, the fuel cell stack receptacle, may be adapted to receive a single fuel cell stack or multiple fuel cell stacks. Each fuel cell stack to be received by the fuel cell stack receptacle may, prior to being inserted into the fuel cell stack receptacle, be placed and held under partial or complete compression (to a predetermined amount) so as to provide for easier handling, alignment and insertion into fuel cell stack receptacle. As noted, where more than one fuel cell stack is placed in the fuel cell stack receptacle, one fuel cell stack may be electrically isolated from the adjacent fuel cell stack by interposing an insulating material between the fuel cell stacks. Compressing and isolating fuel cell stacks may be achieved by any method known to a person of ordinary skill in the art including that disclosed in U.S. Pat. Nos. 6,862,801 and 5,993,987.

A person of ordinary skill in the art may select the physical arrangement of the fuel cell stack(s) and the fuel cell stack peripheral element(s) within the fuel cell system enclosure for a desired application.

The fuel cell stack peripheral may be any balance of plant element including for example, a manifold for the distribution of reactants or coolant, electrical bus bars, end cell heaters, or any other electronic controllers that control the operation of the fuel cell system. For example, FIG. 4 shows fuel cell system 270 which includes peripheral 240, which may be a manifold or electronic controller, and end cell heaters 244, such as that disclosed in U.S. Pat. No. 7,160,640 or other end cell heaters known in the art. The fuel cell stack peripherals may be placed inside the fuel cell stack receptacle after or before the fuel cell stack(s) is/are installed where the appropriate electrical or fluid connections to the stack are made. Alternatively the fuel cell stack peripheral element(s) may be mounted on the pre-compressed fuel cell stack(s), where the fuel cell stacks, together with the fuel cell stack peripheral element(s), may be installed and be compressed together within the fuel cell stack receptacle. The fuel cell stack(s) may then compressed at the full compression load either directly or through a compression plate and sidewalls are mechanically connected to each other so as to maintain the fuel cell stack(s) in a compressed state.

The fuel cell stack receptacle may be assembled in any manner as chosen by a person of ordinary skill in the art. For example, the fuel cell stack peripheral(s) may be first placed on the base. A partially compressed fuel cell stack may then be placed on the fuel cell stack peripheral. Alternatively the fuel cell stack peripheral(s) may be mounted on an unfolded sidewall. Sidewalls may then be attached or folded around the fuel cell stack(s) followed by fasteners being folded around the fuel cell stack(s) so as to attach the sidewalls to one another. The fasteners may then be mechanically attached in a manner disclosed above. Alternatively, the fuel cell stack receptacle may be formed to receive the fuel cell stack peripheral(s) and fuel cell stack(s) following which fasteners mechanically attach sidewalls so as to provide a compression force on the fuel cell stack(s). Alternatively, the fuel cell stack(s) may be fully compressed before sidewalls and fasteners are folded around the fuel cell stack(s) to provide a compression force to maintain the fuel cell stack(s) in a compressed state. In some cases no cell voltage monitoring devices need to be used for controlling the operation of the fuel cell stack(s). Similarly, the end plate heaters and controllers may not be used in the fuel cell power modules used in warm environments. In some cases, the bus bars may be replaced by a cable that connects to the bus plate extension of the fuel cell stack(s).

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to fuel cell system, not necessarily the exemplary embodiments generally described above.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Pat. No. 5,789,091 and U.S. Pat. No. 6,862,801 are incorporated herein by reference, in their entirety. Aspects of the embodiments can be modified, if necessary, to employ systems, circuits, structures and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A fuel cell system comprising:
a first fuel cell stack;
a fuel cell stack peripheral operationally coupled to the first fuel cell stack; and
a fuel cell stack receptacle sized and shaped, when assembled, to receive and at least partially enclose the first fuel cell stack in an interior of the fuel cell stack receptacle and to receive and at least partially enclose the fuel cell stack peripheral in the interior of the fuel cell stack receptacle,
the fuel cell stack receptacle comprising: a base, a plurality of sidewalls and at least one fastener; wherein the fastener, the base and at least one of the plurality of sidewalls are adapted to cooperatively retain the first fuel cell stack in a compressed state.

2. The fuel cell system of claim 1 wherein the fuel cell peripheral retains the first fuel cell stack in a compressed state in cooperation with the fastener, the base, and the at least one of the plurality of sidewalls.

3. The fuel cell system of claim 1 wherein the first fuel cell stack is retained in the compressed state by a compression force of a first predetermined magnitude.

4. The fuel cell system of claim 1, further comprising:
an electrically insulating material interposed between the first fuel cell stack and at least one of the base, the at least one of the plurality of sidewalls and the fastener to electrically isolate the first fuel cell stack from at least one of the base, the at least one of the plurality of sidewalls and the fastener.

5. The fuel cell system of claim 3 wherein the first fuel cell stack is retained in an insulation enclosure in a compressed state of a second predetermined magnitude that is less than the first predetermined magnitude.

6. The fuel cell system of claim 1 wherein the fuel cell stack peripheral comprises a manifold.

7. The fuel cell system of claim 1 wherein the fuel cell stack peripheral is an end cell heater.

8. The fuel cell system of claim 1 wherein the fuel cell stack peripheral is an electronic controller that controls one of the operating parameters of the fuel cell stack.

9. The fuel cell system of claim 1 wherein the fuel cell stack receptacle includes an access panel.

10. The fuel cell system of claim 1 wherein the fuel cell stack receptacle has at least one port that provides access to the interior of the fuel cell stack receptacle for the flow of reactant.

11. The fuel cell system of claim 1 wherein the fuel cell stack receptacle includes at least one electrical junction that provides access to the interior of the fuel cell stack receptacle for the flow of electricity.

12. The fuel cell system of claim 1 wherein the fuel cell stack receptacle further comprises a lid.

13. The fuel cell system of claim 12 wherein the lid is sealed to at least one of the plurality of sidewalls to enclose the first fuel cell stack and fuel cell stack peripheral in the interior of the fuel cell stack receptacle.

14. The fuel cell system of claim 1, further comprising:
a second fuel cell stack; and
an electrically insulating material, wherein the fuel cell stack receptacle is further sized and shaped to receive the second fuel cell stack in the interior of the fuel cell stack receptacle and wherein the insulating material is interposed between the first fuel cell stack and the second fuel cell stack.
